(19) United States
(12) Patent Application Publication
(10) Pub. No.: US 2015/0353020 A1
(43) Pub. Date: Dec. 10, 2015

(54) A FLOOR CONSOLE OF A VEHICLE HAVING A REMOVABLE BIN

(71) Applicant: JOHNSON CONTROLS TECHNOLOGY COMPANY, Holland, MI (US)

(72) Inventor: Arne Dassen, Holland, MI (US)

(21) Appl. No.: 14/760,466

(22) PCT Filed: Jan. 10, 2014
(86) PCT No.: PCT/US2014/010970

§ 371 Date: Jul. 10, 2015

Related U.S. Application Data
(60) Provisional application No. 61/751,514, filed on Jan. 11, 2013.

(51) Int. Cl. B60R 7/04; B60N 3/10; B60N 3/08

(52) U.S. Cl. CPC B60R 7/04; B60N 3/08; B60N 3/101

(57) ABSTRACT

A vehicle interior assembly having a seat and a structure, such as a floor console, adjacent to the seat. The vehicle also includes a bin, such as a removable bin, disposed vertically below a gap formed between the seat and the structure. The bin is configured to capture material that drops vertically through the gap.

### CROSS REFERENCE TO RELATED APPLICATION

This application claims priority from and the benefit of U.S. Provisional Application Ser. No. 61/751,514, entitled “A FLOOR CONSOLE OF A VEHICLE HAVING A REMOVABLE BIN”, filed Jan. 11, 2013, which is hereby incorporated by reference in its entirety.

### BACKGROUND

The invention relates generally to motor vehicles, and more particularly, to a floor console of a motor vehicle having a removable bin.

Certain vehicles include a floor console located between a driver seat and a front passenger seat. The floor console may extend from below a front center console toward a second row of seating and may include an armrest for the driver and/or front passenger. There is often a first gap between the floor console and the driver seat, and a second gap between the floor console and the front passenger seat. During operation and use of the vehicle, debris, personal items, and other material may fall into the first gap and/or the second gap. When material falls into the first gap and/or the second gap, the material may gather on the floor of the vehicle below the first gap and/or the second gap. The portion of the floor below the first gap and/or the second gap may be difficult to access. Accordingly, it may be difficult to retrieve dropped material that falls through the first gap and/or the second gap. Furthermore, the portion of the floor below the first gap and/or the second gap may be difficult to clean.

### BRIEF DESCRIPTION OF THE INVENTION

The present invention relates to a vehicle interior assembly having a first seat and a structure adjacent to the first seat. The vehicle also includes a bin disposed vertically below a first gap formed between the first seat and the structure. The bin is configured to capture material that drops vertically through the first gap.

The present invention also relates to a vehicle interior assembly having a bin configured to be disposed vertically below a gap formed between a seat and a floor console. The bin is configured to capture material that drops vertically through the gap.

The present invention further relates to a vehicle interior assembly having a first seat and a second seat. The vehicle also includes a structure adjacent to the first seat and the second seat. The vehicle includes a bin disposed vertically below a first gap formed between the first seat and the structure. The bin is configured to capture material that drops vertically through the first gap.

### DRAWINGS

FIG. 1 is a perspective view of an exemplary vehicle that includes a floor console that may have a bin configured to capture material that enters a gap between a seat and the floor console.

FIG. 2 is a top view of an embodiment of a floor console with a bin configured to capture material that enters a first gap between a driver seat and the floor console, and to capture material that enters a second gap between a front passenger seat and the floor console.

FIG. 3 is a perspective view of an embodiment of a floor console having a bin configured to capture material that enters a gap between a seat and the floor console.

FIG. 4 is a side view of an embodiment of a floor console having a bin configured to capture material that enters a gap between a seat and the floor console.

FIG. 5 is a side view of an embodiment of the floor console of FIG. 4, with the bin partially removed from the floor console.

FIG. 6 is a side view of an embodiment of the floor console of FIG. 4, with the bin fully removed from the floor console.

### DETAILED DESCRIPTION

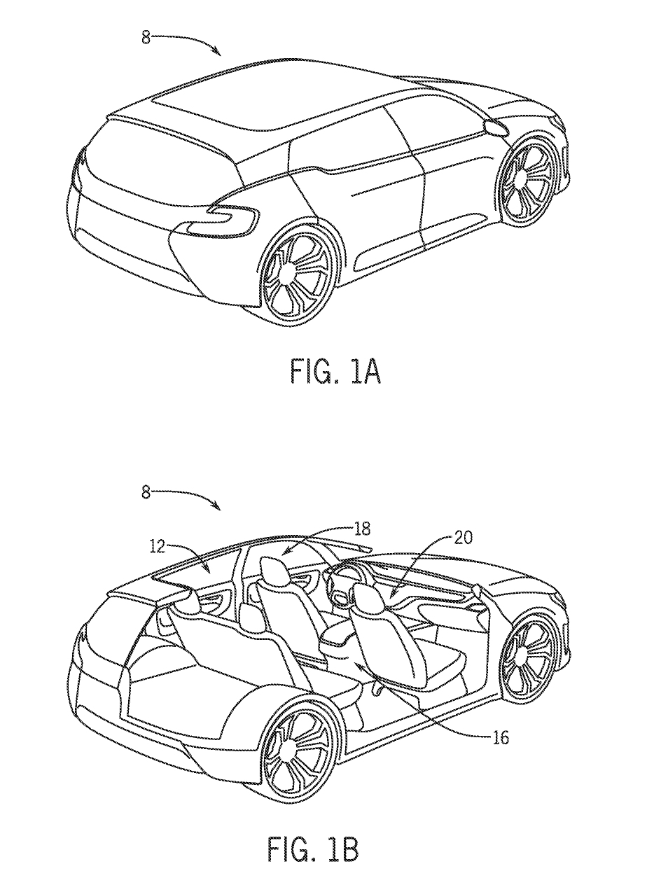

FIG. 1 is a perspective view of an exemplary vehicle 10 that includes a floor console that may have a bin configured to capture material that enters a gap between a seat and the floor console. The vehicle 10, in this case a car, includes an interior 12 and an exterior 14. A floor console 16 is disposed between a driver seat 18 and a front passenger seat 20. The floor console 16 may include a bin disposed vertically below a first gap formed between the driver seat 18 and the floor console 16. Moreover, the bin may also be disposed vertically below a second gap formed between the front passenger seat 20 and the floor console. The bin may capture material that drops through the first gap and/or the second gap. For example, the bin may capture dust, dirt, debris, crumbs, food particles, coins, credit cards, papers, pens, pencils, jewelry, and so forth. Furthermore, the bin may be removable such that material that drops into the bin may be extracted from the bin after removing the bin from the floor console 16. Therefore, the bin may be cleaned so the area vertically below the first and second gaps is clean, thus a floor of the vehicle 10 is kept clean.

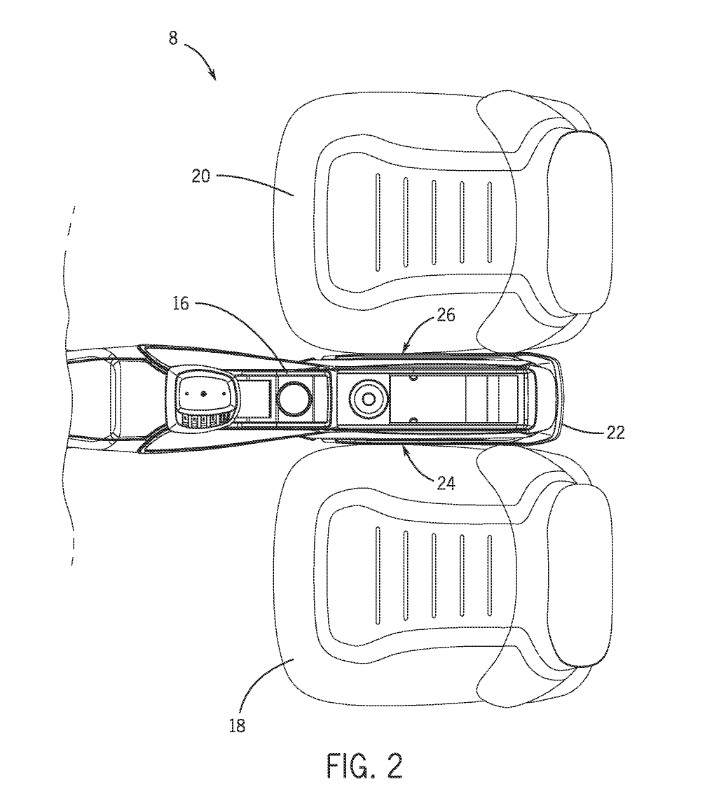

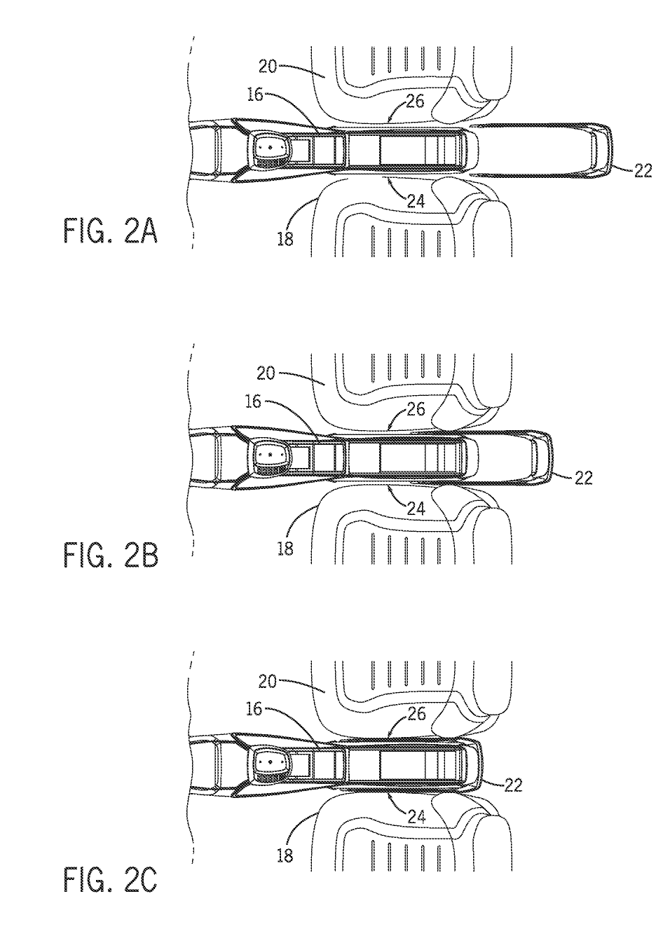

FIG. 2 is a top view of an embodiment of the floor console 16 with a bin 22 configured to capture material that enters a first gap 24 between the driver seat 18 and the floor console 16, and to capture material that enters a second gap 26 between the front passenger seat 20 and the floor console 16. As may be appreciated, material may drop in a vertical direction 28 through the first gap 24 and the second gap 26. The material may be captured by the bin 22 disposed vertically below the first gap 24 and the second gap 26. As illustrated, the bin 22 extends outwardly from the floor console 16 in a first horizontal direction 30 between the floor console 16 and the driver seat 18, and in the first horizontal direction 30 between the floor console 16 and the front passenger seat 20. Moreover, the bin 22 extends outwardly from the floor console 16 in a second horizontal direction 32. In certain embodiments, the bin 22 may be removable from the floor console 16. The extension of the bin 22 in the second horizontal direction 32 may facilitate removal of the bin 22 from the floor console 16.

While the floor console 16 is adjacent to the driver seat 18 and the front passenger seat 20 in the illustrated embodiment, some embodiments may have only the driver seat 18 or only the front passenger seat 20 adjacent to a floor console 16 with a bin 22. Moreover, in certain embodiments, any type of structure (e.g., armrest, tray, another seat, etc.) may be adjacent to the driver seat 18 and/or the front passenger seat 20. Such a structure may include the bin 22 configured to capture material that enters a gap formed between the driver seat 18 and the structure, and/or the front passenger seat 20 and the structure. As discussed above, the bin 22 may capture material that drops through the first gap 24 and/or the second gap 26. Furthermore, the bin 22 may be cleaned to remove material captured therein.

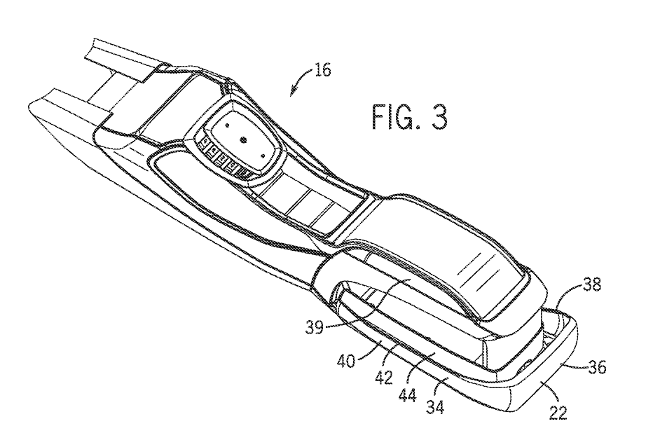

FIG. 3 is a perspective view of an embodiment of the floor console 16 having the bin 22 configured to capture material that enters a gap between a seat and the floor console 16. The bin 22 includes troughs 34, 36, and 38 that extend around three sides of the floor console 16 forming a u-shape around the floor console 16. Specifically, the trough 34 extends outwardly from the floor console 16 in the first horizontal direction 30. In certain embodiments, the trough 34 may be positioned adjacent to the driver seat 18. In such embodiments, the trough 34 is configured to capture material that drops in the vertical direction 28 through the first gap 24 between the driver seat 18 and an upper portion 39 of the floor console 16. Furthermore, the trough 38 also extends outwardly from the floor console 16 in the first horizontal direction 30. In certain embodiments, the trough 38 may be positioned adjacent to the front passenger seat 20. In such embodiments, the trough 38 is configured to capture material that drops in the vertical direction 28 through the second gap 26 between the front passenger seat 20 and the upper portion 39 of the floor console 16. Moreover, the trough 36 extends outwardly from the floor console 16 in the second horizontal direction 32. The trough 36 may also capture material that drops in the vertical direction 28. Furthermore, the trough 36 may function as a handle for removing the bin 22 from the floor console 16. While the bin 22 in the illustrated embodiment includes three sides that extend outwardly from the floor console 16, other embodiments may include 1, 2, 3, or more sides that extend outwardly from the floor console 16.

Each trough 34, 36, and 38 has a u-shape formed by a first side wall 40, a base 42, and a second side wall 44. The u-shape facilitates capturing the material that drops into the bin 22. In other embodiments, each trough 34, 36, and 38 may be formed by any suitable shape configured to capture material that drops into the bin 22, such as a c-shape, l-shape, v-shape, and so forth. Moreover, in some embodiments, the bin 22 may extend horizontally through the floor console 16 such that troughs 34 and 38 are connected together. In certain embodiments, a removable liner (e.g., a trash bag, etc.) may be disposed in the bin 22 to facilitate quick and easy removal of material that is captured by the bin 22. The bin 22 may be formed from any suitable material. For example, the bin 22 may be formed from a polymeric material, a metallic material, and so forth. By using the bin 22, material that drops through gaps formed between the floor console 16 and an adjacent seat (or another adjacent structure) may be captured by the bin 22. Accordingly, the floor area below the gaps may be kept clean from various materials.

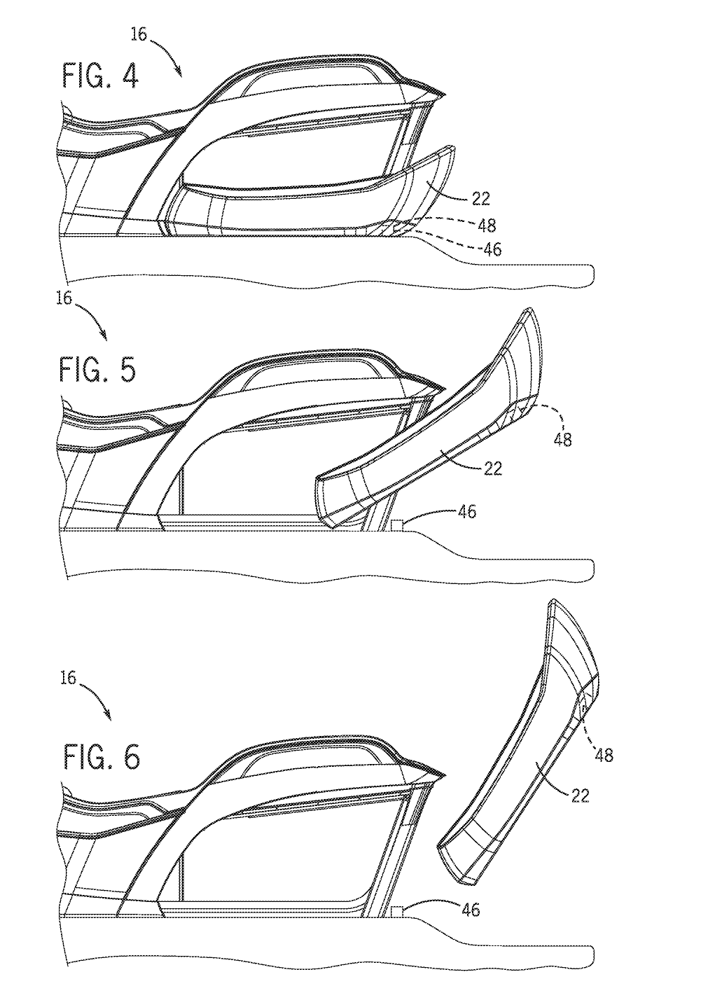

FIG. 4 is a side view of an embodiment of the floor console 16 having the bin 22 configured to capture material that enters a gap between a seat and the floor console 16. The bin 22 is attached to the floor console 16 to block the bin 22 from unintentionally disengaging the floor console 16. For example, the floor console 16 includes a tongue 46 that is inserted into a groove 48 in the bin 22 to attach the bin 22 to the floor console 16. With the bin 22 attached to the floor console 16, the bin 22 may be blocked from disengaging the floor console 16 by movement of the vehicle 10. While a tongue and groove are used in the illustrated embodiment to attach the bin 22 to the floor console 16, any suitable mechanism may be used. For example, a latching mechanism, a locking mechanism, or another device may be used to attach the bin 22 to the floor console 16.

The bin 22 may be lifted out of the floor console 16 to disengage the tongue 46 and the groove 48. Accordingly, FIG. 5 is a side view of an embodiment of the floor console 16 of FIG. 4, with the bin 22 partially removed from the floor console 16. Moreover, FIG. 6 is a side view of an embodiment of the floor console 16 of FIG. 4, with the bin 22 fully removed from the floor console 16. By removing the bin 22 from the floor console 16, the bin 22 may be easily cleaned and/or material may be removed from the bin 22. As such, the floor area below gaps formed between the floor console 16 and an adjacent structure may be kept clean from various materials.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or resequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. An assembly for installation in a vehicle interior adjacent to at least one seat comprising:
a base configured to form a gap between the base and the at least one seat; and
at least one structure configured to be disposed below an opening to the gap wherein the at least one structure is configured to capture material that drops through the opening.

2. The assembly of claim 1, wherein the base comprises a floor console.

3. The assembly of claim 1, wherein the at least one structure is configured to be attached to the base.

4. The assembly of claim 3, wherein the at least one structure is removable.

5. The assembly of claim 1 wherein the at least one structure comprises a bin configured to extend horizontally outward from the base.

6. The assembly of claim 1 comprising a mechanism configured to releasably hold the at least one structure to the base.

7. The assembly of claim 1 wherein the at least one structure is substantially u-shaped.

8. The assembly of claim 1 comprising a liner configured to attach to the at least one structure to capture the material that drops into the at least one structure.

9-10. (canceled)

11. The assembly of claim 1 wherein the at least one structure comprises at least one u-shaped trough.

12. (canceled)

13. An assembly for installation in a vehicle interior between two seats comprising:
a base configured to form a first gap between the base and a first seat of the two seats and to form a second gap between the base and a second seat of the two seats; and
a structure configured to be disposed below a first opening to the first gap and below a second opening to the second gap, wherein the structure is configured to capture material that drops through the first and second openings.

14. The assembly of claim 13 wherein the structure comprises a bin configured to extend horizontally outward from the base.

15. The assembly of claim 13 wherein the structure is substantially u-shaped.

16. The assembly of claim 13 wherein the structure is configured to extend outwardly from at least two lateral sides of the base.

17. (canceled)

18. An assembly for installation on a floor of a vehicle interior between two seats comprising:
a base configured to form a first gap between the base and a first seat of the two seats and to form a second gap between the base and a second seat of the two seats; and
a structure configured to be disposed on the floor below a first opening to the first gap and below a second opening to the second gap wherein the structure is configured to capture material that drops vertically through the first and second openings.

19. The assembly of claim 18 wherein the base comprises a floor console.

20. The assembly of claim 18 wherein the structure comprises a bin configured to extend outwardly from at least two lateral sides of the base.

21. The assembly of claim 1 wherein the at least one structure comprises a continuous trough.

22. The assembly of claim 1 wherein the at least one structure is configured to extend outwardly from at least two sides of the base.

23. The assembly of claim 1 wherein the at least one structure is configured to extend outwardly from a rearward-facing side of the base.

24. The assembly of claim 1 wherein the at least one structure at least partially fits around the base.
